(19) United States
(12) Patent Application Publication
(10) Pub. No.: US 2025/0238750 A1
(43) Pub. Date: Jul. 24, 2025

(54) ARTIFICIAL INTELLIGENCE DRIVEN BUSINESS REPORTING

(71) Applicant: Wells Fargo Bank, N.A., San Francisco, CA (US)

(72) Inventor: Dinesh Heera, Glendale, AZ (US)

(21) Appl. No.: 18/417,930

(22) Filed: Jan. 19, 2024

(51) Int. Cl. G06Q 10/067; G06Q 10/0631; G06Q 10/0637

(52) U.S. Cl. CPC G06Q 10/067; G06Q 10/06315; G06Q 10/06375

(57) ABSTRACT

A financial reporting framework adapted to provide business-specific financial reporting tailored to anticipated reporting needs. The system begins by collecting data encompassing customer transactions, historical financial details, and business-specific parameters, which is analyzed through a blend of artificial intelligence (AI) and machine learning (ML) algorithms. Reporting content is then customized to align with individual business characteristics and requirements. A predictive algorithm further enhances the system, forecasting future reporting needs based on analysis of historical data trends, current financial activities, and market analysis. Thereafter, the system and method enable automatic generation of reports, each precisely tailored to the anticipated future requirements of the business. To maintain accuracy and relevance, the AI and ML algorithms frequently incorporate new data and customer feedback to ensuring reports remain aligned with the evolving needs of commercial banking.

### BACKGROUND

Commercial banking sector is dedicated to addressing the specific financial needs of businesses and guiding the businesses toward success. Traditionally, the commercial banking sector has relied on manual reporting methods, where a customer business chooses what reports to produce and what data to include in the reports based on its understanding of the business requirements. While this approach is functional, it heavily depends on the judgment and knowledge of the customer selecting the reports. This approach also tends to be a time-consuming process.

### SUMMARY

Embodiments of the disclosure are directed to providing tailored reporting based on anticipated reporting needs of a business. In one aspect, a method incorporates a commercial banking reporting system configured for receiving data related to customer transactions, historical financial information, and business-specific parameters for a business, analyzing the received data using a combination of artificial intelligence (AI) and machine learning (ML) algorithms, tailoring reporting content based on the analyzed data, wherein the tailored reporting content is specifically adapted to meet individual business characteristics and requirements, utilizing a predictive algorithm to anticipate future reporting requirements of the business, based on analysis of historical data trends, current financial activities, and predictive market analysis, automatically generating one or more reports that are tailored to the anticipated future reporting requirements of the business, in accordance with the tailored reporting content, and updating the AI and ML algorithms based on newly received data and customer feedback, to enhance a precision of the tailored report content and the accuracy of predictions regarding future reporting.

Embodiments also encompass a computer system for providing tailored, business-specific reporting based on anticipated reporting needs of a business in commercial banking. The computer system is equipped with one or more processors and non-transitory computer-readable storage media which, when executed by the one or more processors, cause the computer system to receive data related to customer transactions, historical financial information, and business-specific parameters, analyze the received data using AI/ML algorithms, tailor reporting content based on the analyzed data to meet individual business characteristics and requirements, utilize a predictive algorithm to anticipate future reporting requirements of the business, automatically generate reports tailored to the anticipated future reporting requirements, and update the AI and ML algorithms based on new data inputs and customer feedback.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example computer system that provides tailored, business-specific reporting based on anticipated reporting needs of a business in commercial banking.

FIG. 2 shows a portion of the computer system of FIG. 1.

FIG. 3 shows an example block diagram of an example forecasting engine of a server of the computer system of FIG. 2.

FIG. 4 shows an example block diagram of an example historical trend engine of a server of the computer system of FIG. 2.

FIG. 5 shows an example block diagram of an example reporting engine of the server of the computer system of FIG. 2.

FIG. 6 shows example physical components of a server of the computer system of FIG. 1.

### DETAILED DESCRIPTION

This disclosure relates to providing tailored reporting based on anticipated reporting needs of a business, performed by a commercial banking reporting system.

This disclosure introduces a commercial banking reporting system that leverages advanced technologies, including artificial intelligence (AI) and machine learning (ML) algorithms, to transform the way tailored reporting is provided to businesses. By analyzing a wealth of data related to customer transactions, historical financial information, and business-specific parameters, the reporting system can anticipate and automatically generate reports tailored precisely to meet the anticipated future reporting needs of businesses. Furthermore, the system refines its algorithms based on newly received data and valuable customer feedback, ensuring precision, agility, and accuracy in the reporting process. In doing so, the reporting system streamlines reporting, providing businesses with the insights and tools they need for financial success while minimizing the burdens of manual report generation.

The reporting system comprises one or more processors and non-transitory computer-readable storage media encoding instructions. These instructions enable the system to receive data related to customer transactions, historical financial information, and business-specific parameters and subsequently analyze this data using AI and ML algorithms. The system tailors reporting content to align with individual business characteristics and requirements and utilizes a predictive algorithm to anticipate future reporting needs. The system further automates the generation of reports tailored to these anticipated requirements and ensures continuous updates of the AI and ML algorithms based on new data inputs and customer feedback.

Additionally, the system encompasses the generation of recommendations and alerts by the computer system to support sustainable economic growth of the business, drawing insights from historical data and market trends. The system also provides alerts related to supply chain disruptions, currency fluctuations, or both. Furthermore, the system offers valuable business insights, identifies opportunities for expansion and revenue growth, and leverages data-driven insights to pinpoint periods of potential higher profitability for the business.

Moreover, the computer system predicts the business's quarterly financial reporting needs using the AI/ML algorithms and identifies potential risks by analyzing historical data and current market trends. The system's automated report generation includes the capability to focus on specific areas of risk and opportunity. Additionally, the system facilitates the update of AI and ML algorithms with new data inputs, customer feedback, and evolving market conditions, ensuring the system's adaptability and accuracy.

This concept introduces a computer system empowered with AI and ML algorithms to streamline report generation, mitigating the need for labor-intensive manual processes and reducing the risk of errors. Furthermore, it advances reporting practices by enabling the creation of shareable reports, real-time notifications, and versatile data presentation formats, surpassing the limitations of conventional human-centric reporting methods, rendering the reporting system an innovation in the domain of commercial banking.

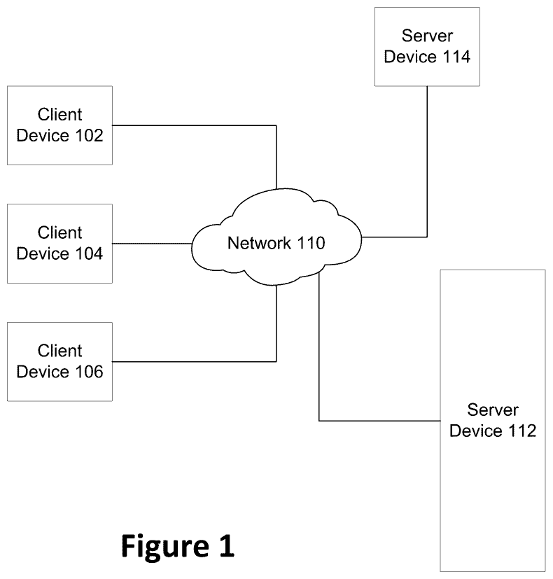

FIG. 1 provides a schematic representation of a reporting system 100 designed for providing tailored reporting based on anticipated reporting needs of a business Although certain embodiments highlight the transfer of data pertinent to online banking and financial systems, specifically in the realm of commercial banking, the overarching principles evinced here are versatile, catering to a diverse range of business domains and operational paradigms.

As depicted in FIG. 1, the reporting system 100 embodies a computing environment including one or more client devices 102, 104, 106 connected to a server device 112 and a server device 114, via a network 110. The client devices 102, 104, and 106 are characterized as computing devices equipped with at least one processor and memory. These client devices cater to the needs of business personnel and customers, facilitating various banking and online financial transactions. Exemplifying versatility, these devices may encompass mobile computing devices, on-premise apparatus, data sources, or other hardware capable of interfacing with network 110 components.

The network 110 functions as the underlying communication framework, ensuring seamless data exchange and interaction between the client devices 102, 104, 106 and one or more server devices. Server device 112 embodies a substantial computing infrastructure, akin to a server farm, and serves as the core entity within this environment. Server device 114, which can be loaded with one or more engines or modules, is configured to deliver tailored reporting services to align with anticipated reporting needs of businesses.

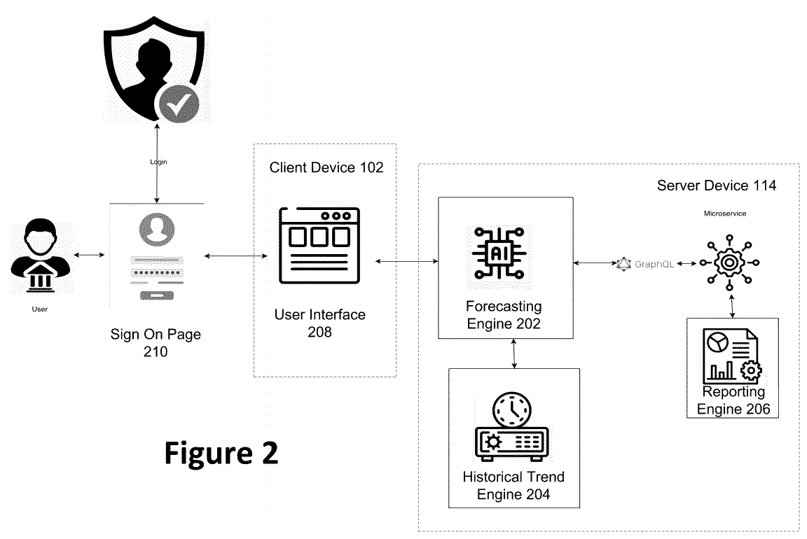

As further depicted in FIG. 2, the client device 102 of FIG. 1 is shown in communication with the server device 114. The server device 114 can comprise one or more engines, with each engine configured as a specialized component adapted to perform specific computational processing tasks within the reporting system 100. For example, in some embodiments, the server device 114 can include a forecasting engine 202, historical trend engine 204, and reporting engine 206.

The forecasting engine 202 can encompass a range of functionalities. The forecasting engine 202 can be tasked with the collection and aggregation of diverse datasets comprising customer transactions, historical financial data, and business-specific parameters. This data retrieval process can entail the utilization of intricate data connectors, data retrieval procedures, and preliminary data preprocessing steps to ensure the acquired data is suitably prepared for in-depth analysis.

Following data acquisition, the forecasting engine 202 can leverage AI/ML algorithms to perform data analysis. This analytical phase can encompass various models, sophisticated feature selection techniques, and data transformation processes, all contributing to a comprehensive understanding of the provided data.

Subsequently, the forecasting engine 202 can customize reporting content, specifically tailoring reports to align with the unique characteristics and precise requirements of individual businesses. In embodiments, this can encompass the generation of reports and content customization, ensuring that the reports are attuned to the distinct needs of each business.

Moreover, predictive algorithms within forecasting engine 202 are responsible for anticipating future reporting requirements. Drawing insights from historical data trends, real-time financial activities, and predictive market analyses, the forecasting engine can aid in determining the future reporting needs of businesses.

To facilitate user interaction and access to the reporting system's 100 functionalities, the forecasting engine 202 provides user interface conductivity. This conductivity empowers users to engage with the forecasting engine 202, to customize reporting parameters, and access the reports generated by the system. Regarding data management, the forecasting engine 202 can oversee the storage of historical data, reporting templates, and generated reports to facilitate efficient data retrieval while ensuring that historical data remains readily accessible.

Furthermore, the forecasting engine 202 can be configured to periodically update the AI and ML algorithms with fresh data inputs, customer feedback, and insights derived from evolving market conditions to ensure that the forecasting engine remains responsive and agile, adeptly adapting to the dynamic landscape of commercial banking.

The historical trend engine 204 is configured to collect historical data, focusing on financial activities and market trends. This data aggregation process provides the raw material necessary for subsequent operations. Drawing from statistical and analytical methods, historical trend engine 204 can examine historical data trends to unveil latent patterns and trends embedded within the historical dataset, contributing to a comprehensive understanding of temporal dynamics. Leveraging machine learning algorithms, historical trend engine 204 can recognize and extract meaningful patterns and trends from historical data, as well as discern relationships that may elude conventional analysis methods.

Further, in some embodiments, the historical trend engine 204 can construct predictive models designed to forecast future market and financial trends. In embodiments, the predictive models can involve the application of time-series analysis techniques and advanced forecasting methodologies to ensure precise predictions. The historical trend engine 204 is also configured to generate visualizations and reports to summarize historical trends and predictive insights, offering valuable decision support for stakeholders and business leaders.

In some embodiments, the historical trend engine 204 can assume the responsibility of managing and preserving historical data, ensuring its accessibility and relevance for subsequent analysis and reporting activities. Moreover, the historical trend engine 204 can provide user interface conductivity, empowering users to explore historical trends, and access reports, enhancing user engagement and the utility of the historical trend analysis.

The reporting engine 206 generally serves to automate the generation of tailored reports to meet the anticipated future reporting needs of businesses. This functionality encompasses the utilization of report templates, data integration processes, and scheduling capabilities, facilitating efficient and customized report production.

In addition to report generation, the reporting engine 206 is equipped to generate recommendations and alerts based on comprehensive analysis of historical data and prevailing market trends. This analytical approach empowers businesses by identifying growth opportunities and potential risks conducive to sustainable economic development.

The reporting engine 206 can additionally focus on monitoring supply chain disruptions and currency fluctuations, promptly delivering alerts when such events occur. These timely notifications enable businesses to proactively address and mitigate adverse consequences.

Leveraging its analytical capabilities, the reporting engine 206 provides valuable business insights, including opportunities for expansion and revenue growth, through data visualization and trend analysis. For example, data-driven insights can be harnessed to identify potential periods of heightened profitability for businesses. Historical data and predictive algorithms collaboratively contribute to these forecasts. Additionally, the reporting engine 206 can evaluate various risk factors by scrutinizing historical data and current market trends, providing valuable insights for risk mitigation strategies.

To enhance financial planning, the reporting engine 206 can predict the quarterly financial reporting requirements of businesses using AI/ML algorithms, incorporating time-series analysis and forecasting techniques for precision. The reporting engine 206 has the capability to tailor the automated report generation process to specific areas of risk and opportunity, ensuring reports align with the immediate concerns or strategic priorities of businesses.

In the realm of accessibility, the reporting engine 206 offers active links corresponding to each generated report, facilitating seamless access to valuable insights and findings. Moreover, the reporting engine 206 provides users with a user-friendly interface, allowing for effortless interaction with the reporting system 100, access to reports, review of recommendations, and management of alerts, thus enhancing the user experience.

As a repository of information, the reporting engine 206 diligently stores historical data, reports, recommendations, and alerts for convenient reference and analysis. Comprehending the paramount importance of data security, the reporting engine 206 enforces rigorous measures encompassing user authentication and access control. These measures preserve the confidentiality and integrity of sensitive business information, ensuring data security and compliance.

With continued reference to FIG. 2, the forecasting engine 202, historical trend engine 204, and reporting engine 206 establish communication with the client device 102, notably through the presentation of information via a user interface 208, which facilitates interaction between these components and the end-user or customer. The user interface 208, situated within the client device 102 serves as a conduit through which users can access, manipulate, and interpret data, reports, insights, and recommendations furnished by the system. In essence, the user interface 208 acts as the mechanism for rendering intricate data and analytical outcomes in a comprehensible manner.

As further depicted in FIG. 2, the user interface 208 features a sign-on page 210 to authenticate user credentials and regulate access to the server device 114 within the reporting system 100. In embodiments, users can be required to input their unique identification credentials, typically consisting of a username and password, as the initial step to access the reporting system 100. These credentials can be subjected to a validation process where they are compared against stored user profiles and authentication protocols to verify user identity.

The sign-on page 210 and the overall user interface within the reporting system 100 can be effectively developed and managed using Micro-Frontends (MFEs). Micro-Frontends are a design approach in web development where the front end of an application is divided into smaller, independent components, each focused on a specific function or business domain, which allows each part of the user interface, such as the sign-on page, to be developed, maintained, and updated independently, facilitating easier management and enhancing the system's adaptability. Additionally, the MFE approach supports scalability, as new features or updates can be integrated as separate micro-frontends without overhauling the entire system.

In some embodiments, the sign-on page 210 can function as a standalone application, dedicated to user authentication, enabling the sign-on page to efficiently handle user credentials, comparing them against stored profiles and authentication protocols to regulate access. By employing a micro-frontend for this component, the system benefits from improved development speed, as multiple teams can work in parallel on different parts of the user interface. Furthermore, this method offers flexibility in choosing the most suitable technologies for different aspects of the interface, enhancing the overall user experience and ensuring robust security for the reporting process.

The reporting system 100 can employ a hierarchy of access levels to efficiently manage user privileges. For example, users with general access can be granted the ability to retrieve and review reports generated by the reporting engine 206. This level of access is intended for standard users who rely on the system's insights and reporting capabilities for their business operations. Conversely, users with elevated access, typically holding administrative or managerial roles, possess extended privileges. They can not only manage approved user access but also modify reporting criteria to better align with evolving business requirements. This system architecture balances security measures with user customization and management capabilities.

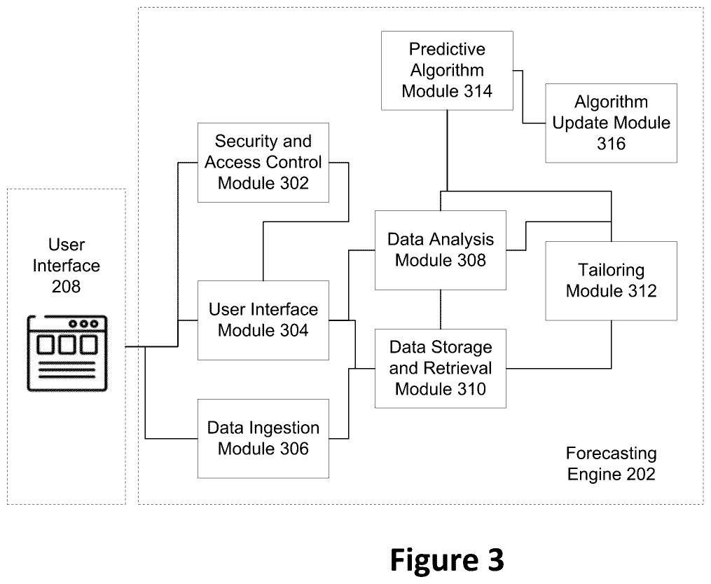

With additional reference to FIG. 3, a block diagram depicting the forecasting engine 202 of FIG. 2 is depicted. In some embodiments, the forecasting engine 202 can include a security and access control module, user interface module 304, data ingestion module 306, data analysis module 308, data storage and retrieval module 310, tailoring module 312, predictive algorithm module 314, and algorithm update module 316, with each of these modules programmed to perform one or more computational functions.

The security and access control module 302 can bolster the reporting system's 100 security framework by encompassing stringent data security protocols, user authentication mechanisms, and access control measures. The objective of the security and access control module 302 is to fortify the reporting system's 100 defenses, encompassing robust data protection, authentication procedures, and precise access authorization to safeguard confidential business data.

The user interface module 304 is configured to provide a user-friendly graphical interface enabling user-driven customization of reporting parameters and the retrieval of reports generated by the forecasting engine 202. In embodiments, the user interface module 304 serves as a conduit for user engagement, enhancing user accessibility and system usability.

The data ingestion module 306 assumes a role in the initial data acquisition phase by serving as the data intake gateway, responsible for receiving diverse data types, including customer transactions, historical financial datasets, and business-specific parameters. The data ingestion module 306 efficiently manages data collection tasks, encompassing data connectors, retrieval mechanisms, and data preprocessing procedures, ensuring data readiness for subsequent analysis.

The data analysis module 308 serves as the analytical nucleus within the forecasting engine 202. Employing advanced AI/ML algorithms, the data analysis module 308 undertakes data analysis tasks involving analytical model execution, feature selection techniques, and data transformation processes to identify insights embedded within the data, and unveil critical patterns and trends for predictive modeling and reporting.

The data storage and retrieval module 310 securely administers historical data repositories, reporting templates, and generated reports, as well as retrieval, optimizing data access efficiency. The data storage and retrieval module 310 plays an important role in ensuring swift data retrieval for responsive reporting and analysis.

The tailoring module 312 specializes in dynamic report customization, driven by data analysis outcomes to enhance the contextual relevance and applicability of generated, and to harmonize the generated reports with individualized business attributes and requirements.

The predictive algorithm module 314 leverages advanced algorithmic techniques to extrapolate data trends, encompassing temporal patterns, current financial transactional dynamics, and predictive market analysis to proactively anticipate forthcoming business needs for forecasting future reporting necessities.

The algorithm update module 316 ensures system adaptability by orchestrating integration of updated AI and ML algorithms, incorporating new data inputs, assimilating customer feedback, and adapting to evolving market conditions. This tuning process involves a series of refinements and adjustments to the predictive algorithms based on a range of dynamic factors. These factors include new data inputs, customer feedback, and changing market conditions, all of which are continuously assimilated into the system.

By regularly updating and fine-tuning the predictive algorithm module 314, the algorithm update module 316 ensures that the predictive capabilities of the reporting system 100 remain highly accurate and relevant, thereby enabling the predictive algorithms to become more sophisticated over time, enhancing their ability to accurately forecast trends and outcomes in dynamic business environments. The result is a system that not only adapts to the present conditions but also evolves in anticipation of future changes, thereby maintaining its relevance and efficacy in decision-making processes.

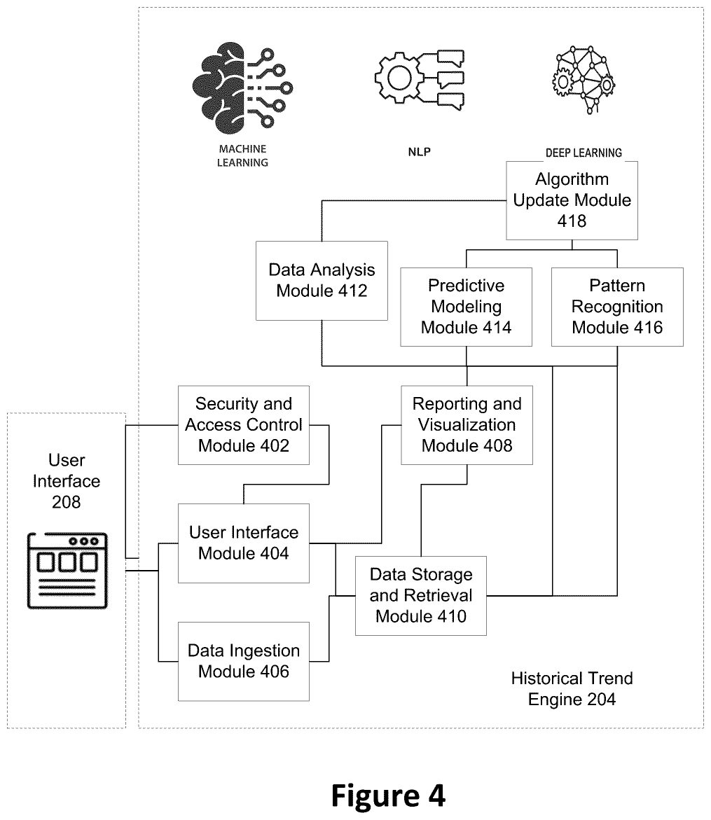

With additional reference to FIG. 4, a block diagram depicting the historical trend engine 204 of FIG. 2 is depicted. In some embodiments, the historical trend engine 204 can include a security and access control module 402, user interface module 404, data ingestion module 406, reporting and visualization module 408, data storage and retrieval module 410, data analysis module 412, predictive modeling module 414, pattern recognition module 416, and algorithm update module 418, with each of these modules programmed to perform one or more computational functions.

The security and access control module 402 is responsible for ensuring data security within the historical trend engine. The security and access control module 402 also manages user authentication and access control, safeguarding sensitive historical trend data from unauthorized access. The user interface module 404 provides a user-friendly interface, enabling seamless interaction between users and the historical trend engine. The user interface module 404 enhances the accessibility of historical trend data and reports, contributing to the system's usability.

The data ingestion module 406 assumes the role of collecting historical data related to financial activities and market trends. The data ingestion module 406 acts as the initial data acquisition point, retrieving and organizing historical data for subsequent analysis.

Within the historical trend engine 204, the reporting and visualization module 408, takes charge of converting intricate historical trend data into comprehensible visualizations and reports to facilitate informed decision-making. The data storage and retrieval module 410 manages the storage and retrieval of historical data, ensuring its accessibility for analysis and reporting purposes.

The data analysis module 412 can employ various statistical and analytical methods to dissect historical data trends. The data analysis module 412 can uncover hidden patterns and trends embedded within historical data, providing valuable insights. Additionally, the data analysis module 412 can incorporate machine learning, which involves the use of algorithms that allow the system to automatically learn and improve from experience without being explicitly programmed. Natural Language Processing (NLP) is another aspect that can be integrated, enabling the system to understand, interpret, and generate human language text. Deep learning, a subset of machine learning, involves neural networks with multiple layers to process and extract complex patterns from data.

In embodiments, the predictive modeling module 414 can leverage historical trends to construct predictive models that forecast future market and financial trends. The predictive modeling module 414 utilizes sophisticated techniques, including time-series analysis and forecasting, to anticipate future trends based on historical data patterns. This module can also incorporate machine learning, NLP, and deep learning to enhance predictive capabilities.

The pattern recognition module 416 can harness machine learning algorithms to identify meaningful patterns and trends within historical data to enhance the analytical depth of the historical trend engine, and it can also incorporate machine learning, NLP, and deep learning to improve pattern recognition.

The algorithm update module 418 ensures the adaptability and improvement of the historical trend engine. In embodiments, the algorithm update module 418 is responsible for integrating updated algorithms by incorporating new data inputs, user feedback, and evolving market conditions, thereby progressively refining predictive capabilities of the reporting system 100. Moreover, the algorithm update module 418 aids in the self-training of AI/ML algorithms to selectively fine-tune the outputs of the data analysis module 412, predictive modeling module 414, and pattern recognition module 416 to align with desired or preferred outcomes, which in some embodiments can be determined based on representative training data.

For example, in some embodiments, the algorithm update module 418 can use historical data or data from similarly situated commercial enterprises as training data. For instance, algorithm update module 418 can use a historical record of requested reports up to a specific date as input data. This data is then used to create predictive outputs regarding the types of records that are likely to be requested after that date. Following this predictive exercise, the algorithm update module 418 evaluates the accuracy of these predictions based on the comparison of predicted records with the actual types of records requested after that date. Subsequently, the outputs of the data analysis module 412, predictive modeling module 414, and pattern recognition module 416 can be tuned and adjusted to improve the accuracy of future outputs. This continuous learning and adjustment process enables the system to become more precise and reliable in its predictions and analysis, adapting over time to better meet the needs and preferences of the users.

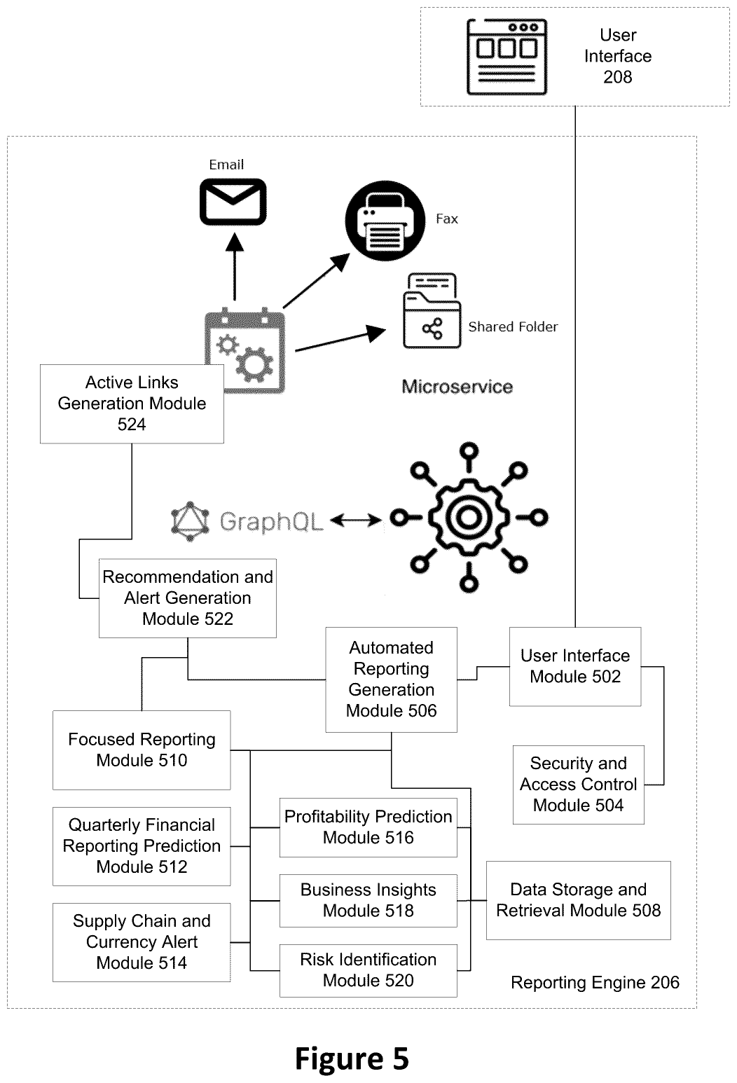

With additional reference to FIG. 5, a block diagram depicting the reporting engine 206 of FIG. 2 is depicted. In some embodiments, the reporting engine 206 can include a user interface module 502, a security and access control module 504, automated reporting generation module 506, data storage and retrieval module 508, focus reporting module 510, quarterly financial reporting prediction module 512, supply chain and currency alert module 514, profitability prediction module 516, business insights module 518, risk identification module 520, recommendation and alert generation module 522, and active links generation module 524, with each of these modules programmed to perform one or more computational functions.

The user interface module 502 presents a user-centric interface facilitating interaction with the reporting engine. The user interface module 502 enables users to efficiently access, view, and manage various reports, recommendations, and alerts, ensuring users can navigate and utilize the platform effectively for their reporting needs.

The security and access control module 504 safeguards the integrity and confidentiality of business data. The security and access control module 504 implements robust user authentication protocols and access control mechanisms. The security and access control module 504 serves as an aid in maintaining data security, thereby ensuring that sensitive business information is accessible only to authorized personnel, thereby mitigating unauthorized access risks.

The automated reporting generation module 506 is tasked with the autonomous creation of reports. The automated reporting generation module 506 anticipates and caters to the future reporting requirements of the business. Incorporating advanced features such as customizable report templates, seamless data integration, and flexible scheduling options, the automated reporting generation module 506 streamlines the reporting process, enhancing efficiency and accuracy.

The automated reporting generation module 506, in addition to its core function of autonomously creating reports, is also equipped with capabilities to determine various aspects of the reporting process to meet specific business needs. This includes setting the frequency at which reports are generated, choosing the format of the reports, deciding on the mode of delivery (such as email, direct download, or integration with other systems), and selecting key value fields that are most relevant for the automated reports. These features ensure that the reports are not only timely and accurate but also tailored to the specific requirements and preferences of the business.

Furthermore, the module offers a level of interactive customization. In some embodiments, the recommendations provided by the automated reporting generation module 506 can be reviewed and confirmed by the customer before the reporting process is initiated. This can be facilitated through user-friendly interfaces such as checkboxes and dropdown menus, allowing customers to easily make modifications and tailor the reports to their anticipated reporting needs. This feature adds an additional layer of personalization, ensuring that the automated reports are not only efficient and accurate but also closely aligned with the specific needs and preferences of the users.

In addition to its inherent functionalities, the automated reporting generation module 506, as well as other modules within the system, are capable of leveraging one or more microservices, such as GraphQL, for executing complex queries. The use of such microservices enables more efficient and flexible data retrieval, allowing for tailored data queries that align with specific reporting needs and dynamically adjust to evolving business requirements. This integration of microservices enhances the module's ability to handle diverse data operations, further optimizing the report generation process.

The data storage and retrieval module 508 serves as a repository to store a comprehensive range of data including historical records, generated reports, recommendations, and alerts. The data storage and retrieval module 508 is designed for optimized data management, facilitating prompt and efficient data access and retrieval, crucial for informed decision-making.

The focus reporting module 510 specializes in generating reports with a specific focus on identified areas of risk and opportunity. The focus reporting module 510 customizes reports to align with particular business concerns or priorities, thereby providing targeted insights and analysis.

The quarterly financial reporting prediction module 512 can utilize advanced AI and ML algorithms, to forecast the quarterly financial reporting needs of the business. The quarterly financial reporting prediction module 512 can incorporate sophisticated time-series analysis and forecasting techniques to provide accurate and timely financial predictions.

The supply chain and currency alert module 514 is dedicated to monitoring supply chain dynamics and currency fluctuations. The supply chain and currency alert module 514 can alert the business about relevant events and disruptions, enabling proactive management of supply chain and financial risks.

The profitability prediction module 516 can leverage data driven insights to predict periods of potential increased profitability. The profitability prediction module 516 utilizes historical data and predictive algorithms to forecast business profitability, aiding in strategic financial planning.

The business insights module 518 is designed to analyze and present valuable business insights. In particular, the business insights module 518 can aid in identifying expansion opportunities and potential for revenue growth, employing data visualization and trend analysis to elucidate business opportunities.

The risk identification module 520 is focused on risk management. The risk identification module 520 identifies potential business risks by analyzing historical data and current market trends, and evaluates various risk factors and offers strategic insights to mitigate identified risks effectively.

The recommendation and alert generation module 522 generates actionable recommendations and alerts based on comprehensive analysis of historical data and market trends. The recommendation and alert generation module 522 identifies both opportunities and potential risks, aiming to foster sustainable economic growth and stability.

The active links generation module 524 enhances report accessibility by generating active links for each automatically generated report. These links facilitate immediate access to the reports and associated insights, improving the usability and effectiveness of the reporting engine. In addition to direct access, this module offers versatile distribution options. Reports can be disseminated to users or designated recipients through various channels, including email, fax, or shared working folders. Furthermore, the active links are configurable, allowing the reports to be made available in a range of downloadable and online formats, catering to diverse user preferences and requirements for report accessibility and format.

In operation, the reporting system 100 can be used to automate reporting needs, as well as to forecast or predict market conditions and make recommendations. For example, in a first potential use case, a hospitality business customer could utilize this system to identify the most profitable periods within a rental season and tailor their marketing efforts accordingly, resulting in a customized marketing campaign.

In such an example, the customer may begin by accessing the platform through the user interface, which features a secure sign-on page. The customer enters their unique credentials (e.g., username, password, etc.) to authenticate and gain access to the system. Once logged in, the customer is directed to the main dashboard of the user interface, where they can navigate to different modules of the system.

On the dashboard, the customer selects automated report generation on the user interface. Here, the customer can specify their reporting needs by choosing options like frequency, format, and key value fields relevant to their business (e.g., occupancy rates, average room prices, peak booking times). The customer can further customize the report by selecting additional parameters through checkboxes and dropdown menus, focusing on data relevant to profitability and marketing.

Once the report parameters are set, the reporting system 100 begins collecting data, which may involve analyzing the customer's transaction history, which includes booking rates, seasonal trends, customer demographics, and revenue data. The system can also integrate external market analysis from additional sources, providing insights into broader market trends, competitor strategies, and customer preferences in the hospitality industry.

The reporting system 100 processes the collected data, utilizing AI and machine learning algorithms to identify patterns and insights. The system then generates a report highlighting the most profitable periods based on historical and market data. The report can include visualizations like graphs and charts for easier interpretation and can suggest optimal times for marketing campaigns and special offers.

Based on the report, the reporting system 100 can propose tailored marketing strategies. For instance, the reporting system 100 can recommend increasing advertising efforts during identified peak booking periods or targeting specific customer segments during low seasons. The system can also provide suggestions on promotional offers, loyalty programs, and personalized marketing tactics to attract and retain customers. If needed, the customer can request additional reports or deeper analyses on specific aspects, such as customer satisfaction or regional market comparisons.

In a second use case scenario, a manufacturing business can leverage the reporting system 100 to effectively manage the challenges posed by fluctuating supply chain prices. In particular, the reporting system 100 can be used to monitor various external economic indicators which directly impact supply chain costs and make recommendations.

In such an embodiment, the system can be programmed to monitor and gather data on relevant economic indicators. This includes tracking global and regional commodity prices (like raw materials), labor cost indices, and consumer price indices, which may directly or indirectly affect the cost of supplies and manufacturing processes.

Thereafter, the collected data is integrated into the reporting system 100, where advanced analytics tools, utilizing AI and machine learning algorithms, analyze the data to identify trends and patterns. In particular, the reporting system 100 can examine the data to identify cyclical patterns in supply chain prices, helping the business understand when prices are likely to rise or fall.

Based on the analysis, the reporting system 100 can predict future trends in supply chain costs, and identify periods when certain supplies are likely to be available at a relative discount or represent a better value. This predictive insight can enable the manufacturing business to plan its procurement strategy, deciding when to purchase more or less of specific supplies.

In some embodiments, the recommendation and alert generation module 522 can suggest optimal times for purchasing supplies based on the analysis. Accordingly, the reporting system 100 can advise, for instance, stocking up on certain raw materials when their prices are predicted to be lower or delaying purchases if a price increase is anticipated.

The user interface 208 of the reporting system 100 allows the business to interact with this data and insights easily. Decision-makers can view reports, graphs, and forecasts related to supply chain prices and receive recommendations for procurement timing. Further, the reporting system 100 can be set up to send alerts and notifications when there are significant changes in the monitored indices or when it is an opportune time to make purchases based on the predictive analysis. These alerts ensure that the business can respond quickly to changing market conditions.

In some embodiments, the reporting system 100 can be integrated with the business's existing procurement and supply chain management processes. This integration ensures that the insights and recommendations are effectively utilized in the business's operational workflow. Accordingly, the reporting system 100 can provide actionable recommendations to aid the business optimize procurement decisions, potentially leading to significant cost savings and improved supply chain efficiency.

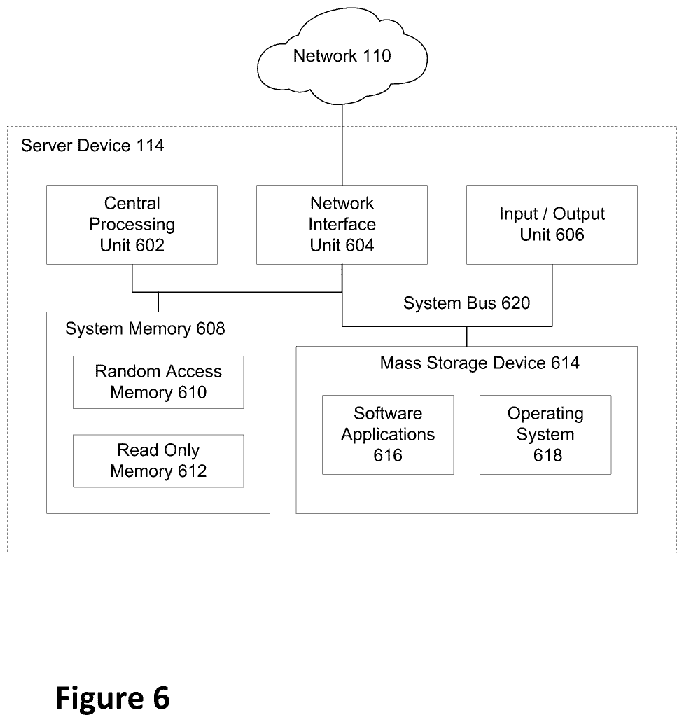

As illustrated in the embodiment of FIG. 6, the example server device 114, which can provide the functionality described herein, includes at least one central processing unit (“CPU”) 602, a system memory 608, and a system bus 620 that couples the system memory 608 to the CPU 602. The system memory 608 includes a random access memory (“RAM”) 610 and a read-only memory (“ROM”) 612. A mass storage device 614 containing the routines that help transfer information between elements within the reporting system 100 (e.g., via the input/output controller 606), such as during startup, is stored in the ROM 612. The server device 114 further includes a mass storage device 614. The mass storage device 614 can store software instructions and data. A central processing unit, system memory, and mass storage device similar to that shown can also be included in the other computing devices disclosed herein.

The mass storage device 614 is connected to the CPU 602 through a mass storage controller (not shown) connected to the system bus 620. The mass storage device 614 and its associated computer-readable data storage media provide non-volatile, non-transitory storage for the server device 114. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 114.

According to various embodiments of the invention, the server device 114 may operate in a networked environment using logical connections to remote network devices through network 110, such as a wireless network, the Internet, or another type of network. The network 110 provides a wired and/or wireless connection. In some examples, the network 110 can be a local area network, a wide area network, the Internet, or a mixture thereof. Many different communication protocols can be used.

The server device 114 may connect to the network 110 through a network interface unit 604 connected to the system bus 620. It should be appreciated that the network interface unit 604 may also be utilized to connect to other types of networks and remote computing systems. The server device 114 also includes an input/output controller 606 for receiving and processing input from a number of other devices, including a touch user interface display screen or another type of input device. Similarly, the input/output controller 606 may provide output to a touch user interface display screen or other output devices.

As mentioned briefly above, the mass storage device 614 and the RAM 610 can store software instructions and data. The software instructions include an operating system 618 suitable for controlling the operation. The mass storage device 614 and/or the RAM 610 also store software instructions and applications 616, that when executed by the CPU 602, cause the reporting system 100 to provide the functionality of the reporting system 100 discussed in this disclosure.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method for providing reporting, comprising:
receiving data related to customer transactions, historical financial information, and business-specific parameters for a business;
analyzing the data using an artificial intelligence (AI) algorithm;
tailoring reporting content based on the data, wherein the reporting content is specifically adapted to meet individual business characteristics and requirements;
utilizing a predictive algorithm to anticipate future reporting requirements of the business, based on analysis of historical data trends, current financial activities, and predictive market analysis;
generating one or more reports that are tailored to the future reporting requirements of the business, in accordance with the reporting content;
updating the AI algorithm based on newly-received data and customer feedback, to enhance a precision of the reporting content and an accuracy of predictions regarding the future reporting requirements.

2. The method of claim 1, further comprising generating recommendations and alerts to support a sustainable economic growth of the business, wherein the recommendations and alerts are based on the analysis of historical data and market trends.

3. The method of claim 1, further comprising providing an alert related to supply chain disruptions or currency fluctuations.

4. The method of claim 1, further comprising offering business insights to the business, utilizing the data to identify opportunities for expansion and revenue growth of the business.

5. The method of claim 1, further comprising employing data-driven insights to identify one or more periods of potential higher profitability for the business.

6. The method of claim 1, further comprising predicting quarterly financial reporting needs of the business using the AI algorithm.

7. The method of claim 1, further comprising identifying potential risks to the business by analyzing historical data and current market trends.

8. The method of claim 1, wherein the generating of the one or more reports includes a capability to focus on specific areas of risk and opportunity.

9. The method of claim 1, further comprising updating the AI algorithm with new data inputs, customer feedback, and evolving market conditions.

10. The method of claim 1, further comprising providing one or more active links corresponding to each of the one or more reports tailored to the future reporting requirements of the business.

11. A computer system for reporting, comprising:
one or more processors; and
non-transitory computer-readable storage media encoding instructions which, when executed by the one or more processors, cause the computer system to:
receive data related to customer transactions, historical financial information, and business-specific parameters;
analyze the data using an artificial intelligence (AI) algorithm;
tailor reporting content based on the data to meet individual business characteristics and requirements;
utilize a predictive algorithm to anticipate future reporting requirements of the business;
generate reports tailored to the future reporting requirements; and
update the AI algorithm based on new data inputs and customer feedback.

12. The computer system of claim 11, further comprising generating recommendations and alerts to support sustainable economic growth of the business, based on analysis of historical data and market trends.

13. The computer system of claim 11, further comprising providing an alert related to supply chain disruptions, currency fluctuations, or both.

14. The computer system of claim 11, further comprising offering business insights for identifying opportunities for business expansion and revenue growth.

15. The computer system of claim 11, further comprising employing data-driven insights to identify periods of potential higher profitability for the business.

16. The computer system of claim 11, wherein the instructions further enable the computer system to predict quarterly financial reporting needs using the AI algorithm.

17. The computer system of claim 11, further comprising identifying potential risks to the business by analyzing historical data and current market trends.

18. The computer system of claim 11, further comprising enabling the computer system to focus on specific areas of risk and opportunity in the reports.

19. The computer system of claim 11, further comprising updating the AI algorithm with new data inputs, customer feedback, and evolving market conditions.

20. The computer system of claim 11, further comprising providing one or more active links corresponding to each of the reports tailored to the future reporting requirements of the business.
